(19) United States
(12) Patent Application Publication
(10) Pub. No.: US 2006/0007227 A1
(43) Pub. Date: Jan. 12, 2006

(54) Method for generating a three-dimensional display

(75) Inventor: Joerg Hahn, Leinfelden-Echterdingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/175,077

(22) Filed: Jul. 5, 2005

(30) Foreign Application Priority Data
Jul. 6, 2004 (DE) DE 10 2004 032 58

(51) Int. Cl. G06F 17/00; G06T 1/00

(52) U.S. Cl. 345/418

(57) ABSTRACT

A method for automatically generating a three-dimensional display of an object on a display device includes generating at least three images of the object to be displayed. The three images show the object from three different observation positions. The three images are displayed in succession on a display device. The additional observation position is on a curve connecting the first and second observation positions. This curve may be an arc of a circle or a straight line, for example. An interval of time between the displaying of an image and the displaying of the next image is defined so that an observer perceives a smooth transition between the three images.

Priority is claimed to German Patent Application No. DE 10 2004 032 586.3, filed on Jul. 6, 2004, the entire disclosure of which is incorporated by reference herein.

The present invention relates to a method for automatically generating a three-dimensional display of an object on a display device.

### BACKGROUND

For example, during the designing of a new motor vehicle, design states are displayed on a screen and evaluated on the basis of computer-accessible design models of the vehicle. These displays and evaluations may be performed even before a physical model of the vehicle is available. A single image of a vehicle generated and displayed with the help of a design model is capable of showing the vehicle from only a single observation direction and does not give an adequate three-dimensional impression.

U.S. Pat. No. 6,057,878 describes a method for automatically generating a three-dimensional display of an object on a display device. A system of recording devices, e.g., a system of cameras, generates multiple images of an object from various observation directions. These images are temporarily stored and displayed on a display device. New images of the object are generated continuously, making it possible to display a change in the object over time.

JP 62262018 A also describes a method for automatically generating a three-dimensional display of an object on a display device. An object is photographed from three different observation directions. The three images generated in this way are displayed one after the other on the same display device.

DE 221067 describes a method for generating three-dimensional depth perception for monocular observation. Two images of an object are alternately projected onto a point. A system for implementing the method includes two objectives, two totally reflecting prisms and two other mobile prisms which generate the sequence of the two images at the point.

EP 0607184 B1 describes a device which shows an observer two displays of an object from two different observation directions. The two displays are displayed in the same location. The two displays are preferably generated by projection from two points, the distance between these two points being essentially equal to the distance between the two human eyes. In one embodiment, the two displays are displayed in alternation, the refresh rate being so high that a human observer cannot perceive the change.

DE 19900009 A1 also describes a method for stereoscopic image generation. Two images of an object are alternately projected onto the same point. The two images are preferably displayed at an image refresh rate between 0.5 Hz and 100 Hz.

DE 3246047 C1 describes a method for generating a three-dimensional display on a display screen by generating an image and displaying it on the screen and then shifting this image in at least one direction. The image refresh rate is between the upper and lower limits of perception of the human eye-brain system. It is proposed that at least two of the three parameters, image size, horizontal position and vertical position of the image, should be varied periodically.

An image refresh rate that is too low often results in a flickering display, which is perceived by an observer as being annoying and unpleasant to look at. However, many display devices are unable to display images with a sufficiently high image refresh rate, so that flickering is prevented. Cathode ray display screens available today typically have an image refresh rate of 85 Hz; liquid crystal display screens have an image refresh rate of 60 Hz. Television screens operate at 25 Hz to 30 Hz.

DE 19736158 A1 describes a method for generating a three-dimensional image. Several images of the object to be imaged are generated from different observation directions. These images are projected side-by-side and preferably simultaneously onto a plane. This method makes it possible to display CAD drawings, for example, on a display screen. A device for implementing the method requires a system of side-by-side, accurately positioned lenses, even when used for CAD drawings. This device is therefore complex to set up and adjust.

### SUMMARY OF THE INVENTION

One object of the present invention is to create a method for automatically generating a three-dimensional display of an object on a display device which does not require the object being displayed to be physically present. A further or alternate object of the present invention is to create a method for automatically generating a three-dimensional display of an object on a display device that will yield a flicker-free display even when using a display device whose maximum image refresh rate would result in flickering with the known methods.

The present invention provides a method for automatically generating a three-dimensional display of an object on a display device, wherein a computer-accessible three-dimensional surface model of the object is specified, a first image of the object is generated by a data processing device using the surface model from a first observation position and a second image of the object from a second observation position, and at least one other image of the object is generated from an additional observation position. The additional observation position is on a curve connecting the first observation position and the second observation position. At least three images are transmitted to the display device and displayed on the display device in such a way that the image is displayed from the first observation position at least twice, between displaying the first and second images and between displaying the second first images, at least one additional image is also displayed each time, and the particular interval of time between displaying one image and displaying the next image to be displayed is defined so that an observer perceives a smooth transition between the at least three images.

A computer-accessible three-dimensional surface model of the object to be displayed is provided. In the execution of the method, at least three images of the object to be displayed are generated. The images are generated by a data processing system using the surface model.

These three images show the object from three different observation positions, namely from a first, a second and an additional observation position. During the execution of the method, these at least three images are displayed one after the other on a display device in such a way that the images from the first observation position are displayed first, then the images from the second observation position are displayed, next the images from the additional observation position are displayed, then the images from the first observation position are displayed and so forth. The additional observation position is on a curve connecting the first and second observation positions. This curve is an arc of a circle or a straight line, for example.

The image from the first observation position is displayed at least twice. At least one additional image is displayed each time between displaying the first and second images and between displaying the second and first images.

The particular time interval between displaying one image and displaying the image that is displayed next is set in such a way that an observer perceives a fluid transition between the three images.

The model is kept constantly in motion. This results in the observer perceiving depth and having a three-dimensional impression of the object. The observer sees the object in motion and from observation directions that include the binocular vision observation directions. Size ratios, curvatures and depth differences are perceived as in stereovision. For example, an observer perceives not only the half of a sphere facing him (as in looking with one eye or in the case of known displays on a computer display screen) but also somewhat more (depending on the diameter of the sphere and the observation distance), specifically as much more as is also the case with binocular vision. Therefore, the display generated according to the present invention is familiar to a person.

This method simulates human stereoscopic vision which is performed unconsciously when observing a real object. The observation position changes continuously between the two eyes when observing a real object. This method automatically simulates such observation without requiring any intervention on the part of the user. In particular, the user need not operate an input device repeatedly.

Due to this method, the observer is able to rapidly estimate the size and shape of the object as well as the distance between the observation position and the object. This object is shown from various observation directions. The observer perceives more areas of the surface model and thus of the object than is the case with known methods. The risk of overlooking something is reduced. Thanks to the present invention, areas of the surface of the object are already visible on the basis of the surface model rather than becoming visible only on the basis of a physical model of the object. Therefore, the method may be tied into the product development process at an early point in time.

This method supports in particular the observation of details. If a detail of the object is observed, the method generates various moving images having that detail.

The method according to the present invention may also be used when using an output device having a low image refresh rate. Since at least three images of the object are displayed, preferably even more images, two successive images differ less from one another than is the case when only two images are displayed, as in known methods. Since the differences are smaller, a lower image refresh rate also yields a flicker-free display of the object on the output device. Many conventional output devices may therefore also be used. It is not necessary to use special output devices.

Furthermore, the method according to the present invention does not require an observer to use stereoglasses or a similar aid for the three-dimensional display or to position lenses in front of the display device.

This method may be used, e.g., for designing motor vehicles in a graphic three-dimensional navigation system in a motor vehicle, for generating technical computer-accessible illustrations, for advertising and sales presentations, in computer games using three-dimensional displays or in a driving simulator for training automobile drivers, railroad train engineers, ship captains or pilots. In all these applications, it is important that a three-dimensional impression approximating reality is generated rapidly.

### BRIEF DESCRIPTION OF THE DRAWINGS

An exemplary embodiment of the present invention is described in greater detail below on the basis of the accompanying drawings, in which:

FIG. 1 shows the position of the surface model and the two limiting observation positions;

FIG. 2 shows the curve between the two limiting observation positions and the additional observation positions;

FIG. 3 shows the instantaneous observation position, variable over time, on the curve between the two limiting observation positions; and

FIG. 4 shows the angle between the limiting observation directions.

### DETAILED DESCRIPTION

The exemplary embodiment is based on the three-dimensional display of a motor vehicle. This motor vehicle functions as the object to be displayed.

This method is preferably performed using a conventional data processing system, e.g., a PC or a workstation. This system includes:
a central processor for performing computation steps,
an input device, e.g., a keyboard, a mouse and/or a trackball,
a display device
and a hard disk memory.

The display device may be, for example, a cathode ray display screen or a liquid crystal display screen (“flat screen”), a television screen or a digital projector which projects images onto a plane, e.g., a white wall. The display device may also include multiple display screens. The central processor is connected to the display device by a graphics card and a data bus. The central processor and the graphics card together generate three-dimensional images of the motor vehicle, each from a different observation position, and transmit these images to the display device. The images thus generated are displayed on the display device.

Using the input device, a user triggers the implementation and termination of the method. The user may also specify the parameters of the method as well as vary these parameters during the implementation of the method. However, it is also possible for the method to proceed fully automatically without any user intervention using the specified parameters after the method has been triggered. Apart from these inputs, the method proceeds fully automatically without additional user inputs intervening in the sequence.

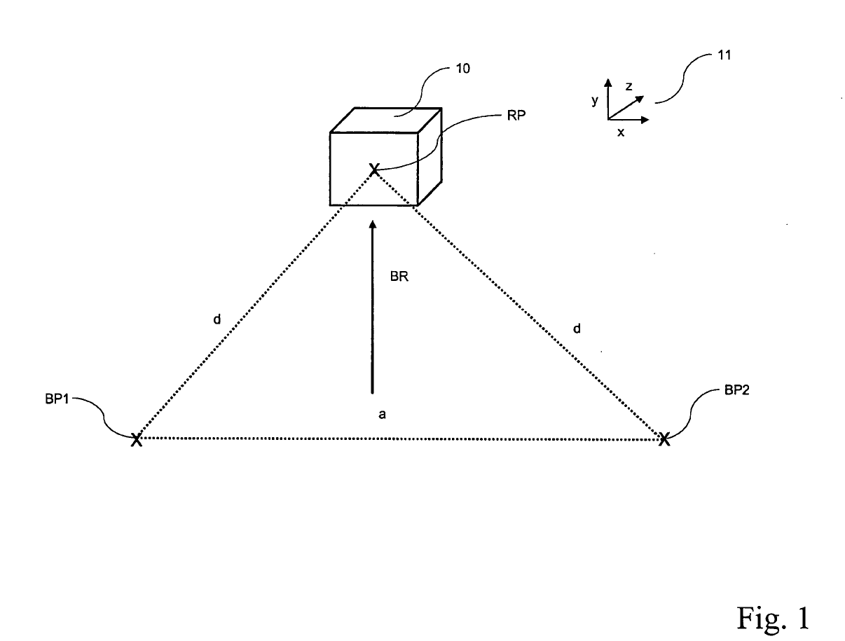

The hard disk memory stores a computer-accessible three-dimensional surface model 10 of the vehicle to be displayed. FIG. 1 shows surface model 10 as well as a first observation position BP1 and a second observation position BP2.

This surface model 10 describes at least approximately the surface of the motor vehicle including all curvatures, recesses, textures, etc. In particular, it describes the external contour of the vehicle body, the outer view of the doors and windows and the decorative trim. Surface model 10, however, does not describe the interior structure of the vehicle. Surface model 10 is generated, for example, from a design model (CAD model). Instead of that, surface model 10 may be generated by scanning a physical exemplar or a physical model, if such is already available. The central processor has read access to this surface model 10. Surface model 10 is analyzed in the course of the method to generate images of the vehicle, but it is preferably not modified.

The surface of the object in surface model 10 is preferably approximated by a plurality of small surface elements, e.g., triangles or quadrilaterals. These surface elements are formed, e.g., by an interconnection of surface model 10 or the surface of the design model. Such an interconnection is known from the finite elements method. The finite elements method is described, for example, in “Dubbel—Taschenbuch flir den Maschinenbau” [Dubbel—Pocketbook for Mechanical Engineering], 20^{th} edition, Springer-Verlag, 2001, C 48 through C 50. A certain quantity of points known as node points is defined in surface model 10. Surface elements whose geometries are defined by these node points are known as finite elements.

At least one three-dimensional Cartesian coordinate system 11 belongs to surface model 10.

A reference point RP on the surface of the motor vehicle is selected automatically. Reference point RP is thus a point on surface model 10. The user specifies a mean observation distance d and a mean observation direction BR_m on surface model 10. The display to be generated is to show the object from a specified mean observation direction BR_m at a specified mean observation distance d. Observation distance d and mean observation BR_m are specified by the user, e.g., by entering a value for each using the keyboard or mouse and a virtual linear-gate regulator. Or the user may modify all the values for mean observation distance d and mean observation direction BR_m, e.g., by rotating or shifting or enlarging (zooming in) or reducing an image of the object already displayed.

A first observation position BP1 and the second observation position BP2 are determined automatically in relation to surface model 10. These two observation positions are each determined by three coordinates in the coordinate system of surface model 10. Both BP1 and BP2 are preferably determined in such a way that they are the specified mean observation distance d from reference point RP of surface model 10. However, it is also possible for them to be different distances from RP.

BP1 and BP2 are also determined in such a way that distance a between BP1 and BP2 is equal to the intraocular distance between the two eyes of an adult human. This intraocular distance and thus distance a between BP1 and BP2 amount to approx. 6.5 cm. In the case of a motor vehicle as the object to be displayed, distance a is very small in comparison with mean observation distance d, which is two meters, for example. However, if the object is a medical appliance to be implanted in a human or another microsystem component, for example, then a may be greater than d. Distance a preferably remains constant during the entire method. However, the user may alter distance a by inputting, e.g., using the keyboard or the virtual slider control.

The display to be generated preferably shows the motor vehicle standing on a flat surface. Two observation positions BP1 and BP2 are selected to be at eye level above the flat surface.

Eye level for an adult human (“50% average person”) is 1.70 meters.

FIG. 1 shows the position of surface model 10 having reference point RP and the two limiting observation positions BP1 and BP2 in relation to one another. BP1, BP2 and RP form the corners of an equilateral triangle. Distance a is greatly exaggerated in FIG. 1 in comparison with mean observation distance d for the purpose of illustration. Furthermore, coordinate system 11 of surface model 10 is also shown in FIG. 1.

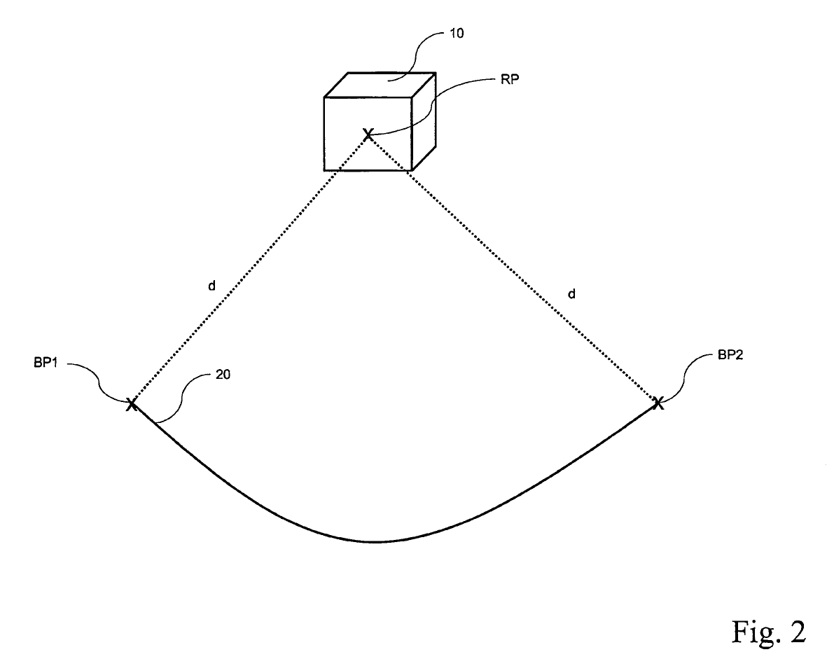

A curve 20 is generated between the two limiting observation positions BP1 and BP2. FIG. 2 shows this curve 20 as an example. Curve 20 is described by a parameter display and is represented in the data processing system. This parameter display defines the quantity of points belonging to curve 20. The parameter display is preferably in the form
{s(r)|rε[a, b]}
where s(r)=[x(r), y(r), z(r)] is a vector describing the position of a point in three-dimensional coordinate system 11 and [a, b] is an interval. The parameter display is selected so that s(a) describes the position of BP1 and s(b) describes the position of BP2.

Curve 20 is, for example, the straight line from BP1 to BP2. Function s(r) then has the form

$$r -> \underline{s} ( r ) = s ( a ) + [ s ( b ) - s ( a ) ] \cdot \frac{r - a}{b - a} .$$

Curve 20 is preferably an arc segment in the plane spanned by RP, BP1 and BP2. All points on curve 20 are then the same distance d from RP. In this embodiment, function s(r) has the form
r→s(r)=RP+(BP1−RP)·cos(r)+d·V2·sin(r),
where v2 is a vector normalized to length l and is the normal vector of differential vector BP2−RP to differential vector BP1-RP. V2 is calculated according to the formula

$$\begin{matrix}V2 = \frac{L2}{‖ L2 ‖} , where \\ L2 = ( BP2 - RP ) - ( BP2 - RP ) \cdot ( BP1 - RP ) \frac{( BP1 - RP )}{{d}^{2}} ,\end{matrix}$$

d=∥BP1−RP∥=BP2−RP∥ because BP1 and BP2 are on an arc segment having midpoint RP. (BP2−RP)·(BP1−RP) is the scalar product of the two differential vectors.

Angle r is between 0 and α, where α is the angle between (BP2−RP) and (BP1−RP). The interval [a, b] is thus equal to [0, α] and therefore rε[0, α].

With the help of surface model 10, various images of the object from different observation positions are generated and displayed on the display device. All these observation positions are on curve 20 between BP1 and BP2. The observation positions on curve 20 yield images of the vehicle from observation directions that vary by mean observation direction BR_m. In one image of the vehicle from one observation direction, only the areas of the surface of the vehicle visible from this observation direction are shown. The various images are shown one after the other, so that an observer perceives a film without flickering or jerking. In this sequence, the motor vehicle is preferably shown running in a rotating periodic back-and-forth movement, which is described in greater detail below.

A period T is specified. In the course of a period of duration T, the instantaneous observation position migrates from BP1 to BP2 in the sequence indicated and back from BP2 to BP1. Exactly one period T elapses between the initial point in time of a display of the image from BP1 and the subsequent display from BP1. The back-and-forth movement is similar. Therefore, period of time Z=T/2 elapses between the start of displaying the first image from BP1 and the start of the subsequent display of the second image from BP2.

Period T is preferably between 2 sec and 2 min, but may also be specified differently. At various points in time t=t_0, t_1, t_2, . . . , an observation position BP(t) on curve 20 is generated, and then an image Abb(t) of the motor vehicle from observation position BP(t) is generated. Observation position BP(t) preferably varies sinusoidally on curve 20 with an increase in t between limiting observation positions BP1 and BP2.

An angular velocity ω=2π/T results from period T. Observation position BP(t) at point in time t is calculated according to the formula

$$BP ( t ) = \underline{s} \{ \frac{a + b}{2} + \frac{b - a}{2} \cdot sin ( ω \cdot t ) \}$$

with a sinusoidal variation, where s=s(r) is the function of the parameter display of curve 20.

Resulting observation direction BR(t) also varies sinusoidally, namely according to the formula BR(t)=RP−BP(t), where RP is the reference point of surface model 10. Mean observation direction BR_m is equal to BR(0).

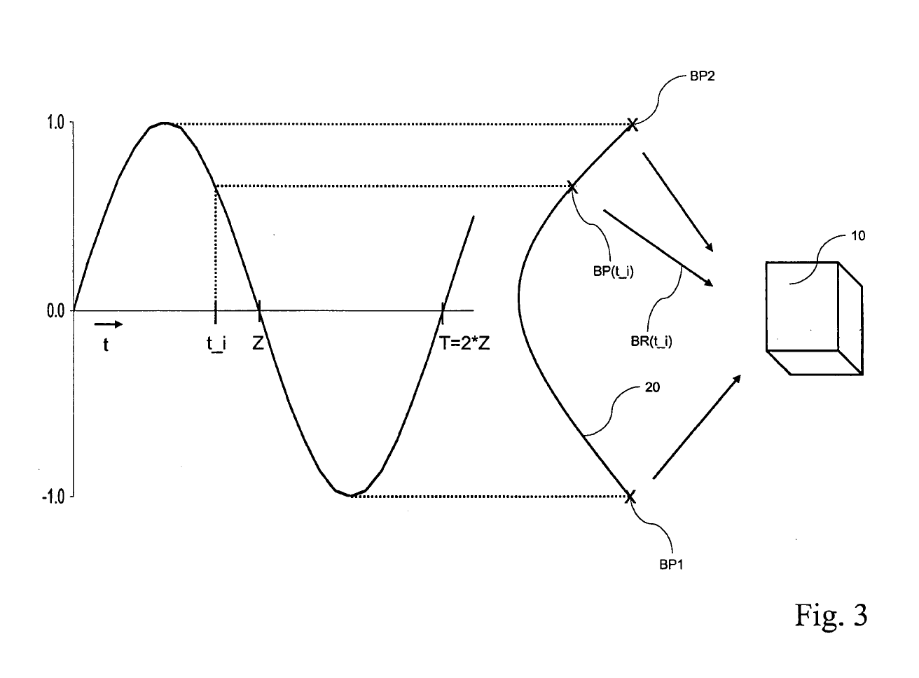

FIG. 3 illustrates the determination of observation position BP(t_i) at point in time t_i. The left part shows a sine curve. At a point in time t_i, the value sin(ω·t_i) is calculated. According to the formula

$$BP ( x ) = \underline{s} \{ \frac{a + b}{2} + \frac{b - a}{2} \cdot sin ( ω \cdot t\_i ) \}$$

a point on curve 20 is selected as computation position BP(t_i). Image Abb(t_i) at point in time t_i shows the motor vehicle from observation direction BR(t_i) and is generated with the help of surface model 10.

An image refresh rate f that is constant over time is preferably determined as described below. This image refresh rate f species how many images per second are generated and displayed. Points in time t_0, t_1, t_2, . . . mentioned above are determined in this embodiment so that: t_i=t_0+i/f for i=0, 1, 2, . . . . During a period T, a total of T·f images are generated and displayed.

Image refresh rate f is determined so that an observer perceives a smooth transition between images Abb(t_0), Abb(t_1), Abb(t_2), . . . . This requirement is met when f amounts to at least 25 Hz. Conversely, it is determined in such a way that the central processor and the display device are able to follow the image refresh rate.

The display device has a maximum image refresh rate f_Anz as a function of the equipment and is capable of displaying only f_Anz images per second. Cathode-ray-tube display screens available today typically have an image refresh rate of f_Anz=85 Hz; liquid crystal display screens have an image refresh rate of f_Anz=60 Hz. Television screens work with f_Anz=25 Hz to 30 Hz. Therefore, image refresh rate f is less than or equal to f_Anz.

The image processing system having a central processor, graphics card and data bus also has a maximum image refresh rate f_DV determined by the system. This depends in particular on the computation power and clock rate of the central processor and the graphics card, the transmission rate of the data bus and on surface model 10. Maximum achievable image refresh rate f_DV is often given as frames per second. Image refresh rate f is selected to be less than or equal to f_DV. A modification of this embodiment makes it possible to generate a three-dimensional display even when f_DV is less than 25 Hz. The same image is displayed repeatedly in succession, namely preferably [25/f_DV]+1 times, where [x] is the largest natural number smaller than x. The movement is perceived as retarded accordingly.

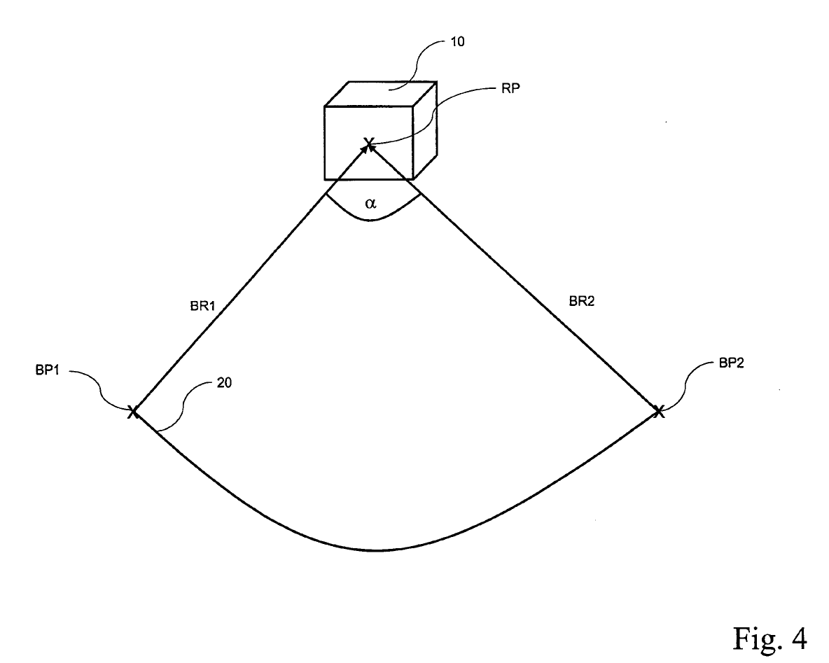

The angle between two successive observation directions BR(t_i) and BR(t_i+1) is not variable over time in this exemplary embodiment, which is illustrated by reconstructing FIG. 3. An upper limit may be specified for maximum angle Δα between two successive observation directions. A lower limit for f may be derived from this specified upper limit as follows. Let α be the angle between limiting observation directions BR1 and BR2. FIG. 4 illustrates this angle α.

Because of

$${α}^{′} ( t ) = \frac{ωα}{2} cos ( ω t ) ,$$

therefore

$$Δ α \geq \frac{ωα}{2} \frac{1}{f} .$$

It also holds that

$$f \geq \frac{ωα}{2} \frac{1}{Δ α} = \frac{π}{T} \frac{α}{Δ α} .$$

The lower limit for f is thus (π·α)/(T·Δα). It is possible for this lower limit for f to be larger than image refresh rate f_Anz of the display device or image refresh rate f_DV of the data processing system, i.e., (π·α)/(T·Δα)>f_Anz or (π·Δα)/(T·Δα)>f_DV. In this case, the period is prolonged, preferably to

$$T = \frac{π}{min ( f\_Anz , f\_DV )} \cdot \frac{α}{Δ α} .$$

This embodiment ensures that a specified limit Δα will be maintained.

An observer may alter the following parameters of the method via the input device while the images are being displayed:
mean observation distance d,
mean observation direction BR_m,
an upper limit for maximum value Δα between two successive observation directions and
minimum period T or half of minimum period Z.

This change preferably has an immediate effect on the method. If d or BR_m is altered, a new parameter display for curve 20 is calculated and used. For example, distance d is reduced continuously as a function of inputs by the user, which results in a continuous enlargement of the vehicle in the figures. If period T is reduced, the back-and-forth movement appears to be more rapid than before. The observer is able to prevent any flickering of the display by an increase in image refresh rate f within the allowed limits.

In one embodiment of this method, a computer-accessible film file is generated and stored with the help of the sequence of images Abb(t_0), Abb(t_1), Abb(t_2), . . . of the vehicle. This film file is generated in a data format for computer-accessible films. To display the film again later, only the film file and a playback program are needed, but surface model 10 is not needed. The playback program inputs the film file and plays back the display as a film on the display device. The film file usually requires much less memory than surface model 10. The playback program makes lower demands of the data processing system than the method for generating the three-dimensional display.

What is claimed is:

1. A method for automatically generating a three-dimensional display of an object on a display device, the method comprising:
specifying a computer-accessible three-dimensional surface model of the object;
generating a first image of the object by a data processing device using the surface model from a first observation position and generating a second image of the object from a second observation position;
generating at least one further image of the object from a further observation position disposed on a curve connecting the first observation position and the second observation position;
transmitting the first, second, and at least one further images to the display device; and
displaying the first, second, and at least one further images successively on the display device with a time interval between each successive display, the first image being displayed at least twice, wherein the at least one further image is displayed between the displaying of the first and second images and between the displaying of the second and first images, and wherein the time interval is defined so that a smooth transition is perceived between the at least three images.

2. The method as recited in claim 1, further comprising:
defining an angle between the first and second observation positions and an image refresh rate of the display so that a rotational movement is perceived alternately in one direction of rotation and in an opposite direction of rotation, wherein an angular velocity of the direction of rotation is less than or equal to a specified upper limit.

3. The method as recited in claim 1, further comprising:
selecting a sequence of observation positions disposed one after the other on the curve;
generating an additional image from each of the sequence of observation positions using the data processing device so as to provide a sequence of additional images;
transmitting the sequence of additional images to the display device;
displaying the sequence of additional images between the displaying of the first and second images; and
displaying the sequence of additional images in reverse order between the displaying of the second and first images.

4. The method as recited in claim 3, wherein the displaying of the first image, the image sequence, the second image and the image sequence in the reverse order is periodically repeated.

5. The method as recited in claim 3, wherein the generating and displaying is performed so that a specified period of time elapses between a start of the displaying of the first image and a start of the subsequent displaying of the second image, and between a start of the displaying of the second image and a start of the subsequent displaying of the first image.

6. The method as recited in claim 5, further comprising specifying a maximum image refresh rate of the method, and wherein a total number of images generated and displayed during the specified period is equal to or smaller than a product of the specified period and the maximum image refresh rate.

7. The method as recited in claim 6, wherein the maximum image refresh rate of the method is specified to be equal to or smaller than a specified maximum image refresh rate of the display device and equal to or smaller than a specified maximum image refresh rate of the data processing device.

8. The method as recited in claim 1, wherein the first observation position and the second observation position are disposed at a same distance from the object, and wherein the further observation position is on an arc of a circle between the first observation position and the second observation position.

9. A computer readable medium having stored therein computer executable steps operative to perform the method as recited in claim 1.

10. A computer program product loadable into the internal memory of a computer and including software steps executable when the product is running on a computer to perform the method of claim 1.
